(19) United States
(12) Patent Application Publication
(10) Pub. No.: US 2003/0067616 A1
(43) Pub. Date: Apr. 10, 2003

(54) Image processing apparatus and image processing method

(76) Inventors: Yasutaka Toyoda, Hitachi (JP); Tatsuki Inuduka, Tokyo (JP); Makoto Tsumura, Hitachi (JP); Yuka Utsumi, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/082,184

(22) Filed: Feb. 26, 2002

(30) Foreign Application Priority Data
Oct. 5, 2001 (JP) 2001-310355

(51) Int. Cl. H04N 1/52; H04N 1/60

(52) U.S. Cl. 358/1.9; 358/518; 358/3.03; 358/535

(57) ABSTRACT

A color correction table which contains a correspondence relationship between a discrete input color signal and an output color signal is employed. An inputted color signal is corrected by a signal correcting unit, and an approximating unit acquires a discrete input color signal approximated to the corrected input color signal. A table referring unit refers to the color correction table to output an output color signal which corresponds to the input color signal approximated by the approximating unit. An approximate error producing unit calculates an approximate error from difference between the input and output signals supplied to the approximating unit, and then stores this calculated approximate error into a data holding unit. The stored approximate error is supplied to a signal correcting unit to be used in the correction of the input signal.

### BACKGROUND OF THE INVENTION

The present invention generally relates to image processing, and more specifically, to an image processing apparatus and an image processing method for executing a color correction with respect to image data entered in this image processing apparatus, and for converting gradation of the color-corrected image data.

Currently, very conspicuous improvements are made in performance of electronic devices capable of inputting, displaying, and outputting color images. As typical electronic devices, the following devices are commercially available, namely, a digital still camera equipped with such a CCD (Charge-Coupled Device) having pixel density of 600 millions or higher pixels; an inkjet printer capable of achieving print density of 2400 dpi; and a slim-type LCD (Liquid Crystal Display) driven under low voltages. However, while these electronic devices own the reproducibility characteristics specific to these devices, there is such a problem that, for example, colors of color images photographed by a digital still camera can be hardly displayed on an LCD in a correct manner.

With respect to a color reproducibility characteristic of an electronic device, an optically rotating dispersion characteristic of a liquid crystal panel used in a display unit of an LCD, and a spectral characteristic of ink used in a color printer will now be exemplified. It should be understood that an optically rotating dispersion characteristic of a liquid crystal panel of an LCD corresponds to such a characteristic that an optical transparency of the liquid crystal panel is changed in response to a wavelength of light, and also, a changing manner of this optical transparency is made different from each other in response to an applied voltage. Concretely speaking, with respect to an optical transparency characteristic of a liquid crystal panel while a low voltage is applied thereto, the following problem may occur. That is, a red color components (long wavelength region) of light are increased, whereas blue color components (short wavelength region) thereof are decreased. Also, even when a gray scale is displayed, white balances become unbalance in the respective gradation, and the display screen of the liquid crystal panel is colored in response to an applied voltage.

A spectral characteristic of ink of a color printer corresponds to such a characteristic related to the respective ink such as cyan, magenta, and yellow colors, which are used in a printing operation. Since presently-available ink does not own ideal spectral characteristics of cyan, magenta, and yellow colors, there are the below-mentioned problem. That is, a color range which can be reproduced by a color printer is very narrow, as compared with color ranges of a CRT (Cathode-Ray Tube) and an LCD, so that this color printer cannot realize color representations having high saturation.

To correct such a color reproducibility characteristic by executing a signal process operation, JP-A-63-2669 discloses one correction manner. In this disclosed conventional technique, the RGB three-dimensional color correction table is prepared in correspondence with all of possible combinations of the three color (R, G, B) signals. While the color correction data capable of correcting the color characteristics of the above-described electronic devices are stored in this color correction table, the color correction operation is carried out with reference to this color correction table.

However, since the storage capacity of the used color correction table is a very large capacity (namely, storage capacity of color correction table of 8-bit RGB colors is approximately 50 MB), this conventional color correction manner may not be practically utilized. Under such a circumstance, in order to reduce this storage capacity of the above-explained color correction table, the below-mentioned ideas have been proposed in JP-A-4-144481 and JP-A2001-112015. That is, these conventional techniques are not directed to such an idea that the color correction tables are prepared with respect to the all possible combinations of the R, G, B colors. Instead, these conventional ideas may reduce the storage capacities of the table memories in accordance with the following manners. That is, the color-corrected results are stored only as to the respective grid (lattice) points which are formed by subdividing the three-dimensional color space constructed of the three color (R, G, B) signals with a properly-selected interval in the grid shape, so that the storage capacities of the table memories may be reduced. As to such color data other than the grid points, the grid regions containing these color data are extracted, and then the linear interpolating process operation is carried out with reference to the correction data of the respective grid points. For instance, in a case that the color information of R, G, B is color-corrected so as to obtain such colors of R′, G′, B′, while referring to the correction data of the eight grid points in the vicinity of the image data of the original color image, the linear interpolating calculation is carried out with respect to the entered original color image data. For example, the interpolating calculation formula used to acquire the color-corrected color of R′ may be expressed by the following formula:

R′=(1−r)(1−g)(1−b)R(R, G, B)+r(1−g)(1−b)R(R+1, G, B)+(1−r)g(1−b)R(R, G+1, B)+(1−r)(1−g)bR(R+1, G, B+1)+rg(1−b)R(R+1, G+1, B)+r(1−g)bR(R+1, G, B+1)+(1−r)gbR(R, G+1, B+1)+rgbR(R+1, G+1, B+1)

In the above-described linear interpolating calculation formula, eight values of “R(R, G, B), −, R(R+1, G+1, B+1) present in the right hand correspond to correction values of “R”, which are obtained by the color correction as to eight grid points located in the vicinity of data of interest with reference to the color correction table. With respect to these values, linear interpolating calculation is carried out by utilizing both positions on the color space by the respective color signals of the original color data and distances (r, g, b, 1−r, 1−b, and 1−g) measured from the respective grid points, so that correction values of the original color data are obtained.

However, while the above-described conventional techniques may reduce the storage capacity of the color correction table, multiplying calculation should be carried out 24 times as well as adding calculation should be performed 7 times in order to execute the color correction calculations as to one color component of the original color image. As a consequence, there is another problem that a total calculation amount becomes very large, and thus lengthy processing time is necessarily required.

### SUMMARY OF THE INVENTION

On the other hand, as to image devices such as an LCD and a printer, various types of limitations are made in a total representative gradation number per pixel. For instance, there are an LCD whose gradation number is limited only to 64 gradation numbers, and a printer whose gradation number is restricted only to 2 gradation numbers. The image devices utilize such a system that a gradation number of an input signal is expressed in a simulation (pseudo) manner by employing a smaller gradation number than that of the input signal, namely a dither method (for instance, B. E. Bayer: An Optimum Method for Two-Level Rendition of Continuous Tone Pictures, ICC Conference Record 26-11 to 26-15, 1973). In a dither method, while using a matrix formed by threshold values are arrayed within a very small area which is expressed by way of pseudo-gradation, gradation of input data is converted by utilizing both a coordinate position of input data and a threshold value of this matrix, corresponding to this coordinate position. It should also be noted that such pseudo-gradation representation may also be utilized as another purpose capable of reducing a data amount. In general, a total number of gradation which can be recognized by a human may differ from each other, depending upon resolution of pixels which form an image. Therefore, for instance, this dither method may also be utilized in order that resolution of an image device is increased to a degree at which gradation of pixels cannot be recognized, and total gradation numbers of the respective pixels are reduced.

As previously described, in such a case that both the color correction process operation and the gradation process operation are carried out in a continuous manner, the color correction operation occupies the major operation, and thus, the processing time required for this color correction operation is very prolonged.

The present invention has been made to solve the problems of the above-explained conventional techniques, and therefore, has an object to provide both an image processing apparatus and an image processing method, capable of reducing a memory capacity of a color correction table, and also capable of obtaining a result suitably adapted to a gradation reproductivity capability of an electronic device without utilizing a complex calculation.

To achieve the above-described object, an image processing apparatus, according to an aspect of the present invention, is featured by such an image processing apparatus in which a color correction table containing a correspondence relationship between an input color signal and an output color signal in a table form is utilized in a conversion operation between color signals, comprising: a color correction table holding unit for storing thereinto a color correction table which contains a correspondence relationship between a predetermined discrete input color signal and an output color signal in a table form; an approximating unit for approximating an entered input signal to the discrete input color signal of the color correction table to thereby output the approximated color signal; an approximate error producing unit for calculating an approximate error based upon both the color signal inputted into the approximating unit and the color signal outputted from the approximating unit; an approximate error holding unit for holding thereinto the approximate error calculated by the approximate error producing unit; a signal correcting unit for correcting the color signal entered into the approximating unit by employing the approximate error held in the approximate holding unit; and an output unit for outputting an output color signal which corresponds to the input color signal outputted from the approximating unit with reference to the color correction table.

The output color signal outputted from the output unit may be constituted by gradation data which can be represented by a device into which the output color signal is entered, and data used to switch the gradation data by way of a dither process operation.

The image processing apparatus of the present invention is further comprised of a dither processing unit for comparing the data used to switch the gradation data with a dither matrix in which threshold values are arranged to thereby output a dither result; and an adding unit for adding the dither result to the gradation data.

The approximating unit may compare an inputted color signal with a threshold value provided between the discrete input color signals so as to determine such a discrete color signal which is approximated to the inputted color signal.

Intervals among the discrete input color signals of the color correction table are not equi-intervals. Alternatively, the discrete input color signals of the correction table may be such color signals which correspond to minimum gradation, maximum gradation, and gradation equal to the respect subdivided points in such a case that a total gradation number of an input color signal is equally subdivided by “N” (symbol “N” being 2 or more positive integers).

Also, an image processing method, according to another aspect of the present invention, is featured by an image processing method comprising: a step for correcting an inputted color signal; a step for using a color correction table containing a correspondence relationship between a predetermined discrete input color signal and an output color signal in a table form so as to acquire the discrete input color signal which is approximated to the corrected input color signal; a step for calculating an approximate error based upon both the corrected input color signal and the approximated color signal; and a step for outputting an output color signal corresponding to the approximated input color signal with reference to the color correction table, wherein the approximate error is used so as to correct a color signal which is inputted subsequent to the first-mentioned input color signal.

The output color signal corresponding to the approximated input signal may be constituted by gradation data which can be represented by a device into which the output color signal is entered, and data used to switch the gradation data by way of a dither process operation.

The image processing method of the present invention is further comprised of a step for comparing the data used to switch the gradation data with a dither matrix in which threshold values are arranged to thereby output a dither result; and a step for adding the dither result to the gradation data.

As previously explained, the color converting operation which would conventionally require the very complex calculation process operations can be realized in such a manner that the unprocessed signal is corrected by utilizing the approximating operation and the approximate error to the color signals corresponding to the color correction table. As a consequence, both the processing time and the circuit scale can be reduced. Furthermore, since both the gradation data corresponding to the representative color signals and the switching data by the dither process operation are stored in the color correction table, the separation operation from the input signal to the switching data used to execute the threshold value comparison in the dither operation can be reduced. Also, the dither operation can be carried out in a high speed.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for schematically showing a structural example of an image processing apparatus according to the present invention.

FIG. 2 is a diagram for illustratively indicating a structural example of both a liquid display apparatus equipped with the image processing apparatus, and an image signal input apparatus.

FIG. 3 is a diagram for illustratively indicating a correction method of a signal correcting circuit.

FIG. 4 is a diagram for indicating an example of a content of a correction table.

FIG. 5 is conceptional diagram of a correction table in which color space constituted by color signals is subdivided in a grid shape.

FIG. 6 is an explanatory diagram for explaining a correspondence relationship between the correction table and correction signals.

FIG. 7A and FIG. 7B are diagrams for illustratively showing a method of forming the correction table.

FIG. 8 is an explanatory diagram for explaining a dither operation.

FIG. 9 is a diagram for schematically indicating operations of a multi-gradation dither.

FIG. 10 is a diagram for schematically indicating stages of converting input/output signals of the image processing apparatus according to the present invention.

FIG. 11 is a flowchart for explaining process operation executed in a case that the image processing operation of the image processing apparatus of the present invention is realized by way of software.

FIG. 12 is a schematic block diagram of an application apparatus of the image processing apparatus according to the present invention.

FIG. 13 is a schematic block diagram of embodiment 1 in which the image processing apparatus of the present invention is mounted on a liquid crystal display apparatus having a digital interface.

FIG. 14 is a schematic block diagram of embodiment 2 in which the image processing apparatus of the present invention is mounted on a liquid crystal display apparatus having an analog interface.

FIG. 15 is a schematic block diagram of embodiment 3 in which the image processing apparatus of the present invention is mounted on a display apparatus for performing a gradation display by employing a plurality of sub-fields.

FIG. 16 is a diagram for illustratively indicating a technical idea of executing the gradation display by employing a plurality of sub-fields.

FIG. 17 is a block diagram of embodiment 4 in which the image processing apparatus of the present invention is mounted on a printer apparatus.

FIG. 18 is a conceptional diagram for representing a correction table in which a color space constructed of color signals is subdivided in a grid shape.

FIG. 19 is a graph showing transition of approximate errors Ei.

FIG. 20 is a diagram showing the image due to approximate coordinate values C.

### DESCRIPTION OF THE EMBODIMENTS

Referring now to the accompanying drawings, embodiment modes according to the present invention will be explained. First, while a signal processing operation of an RGB multi-value image is exemplified, a basic structure of a signal processing apparatus according to the present invention will now be described.

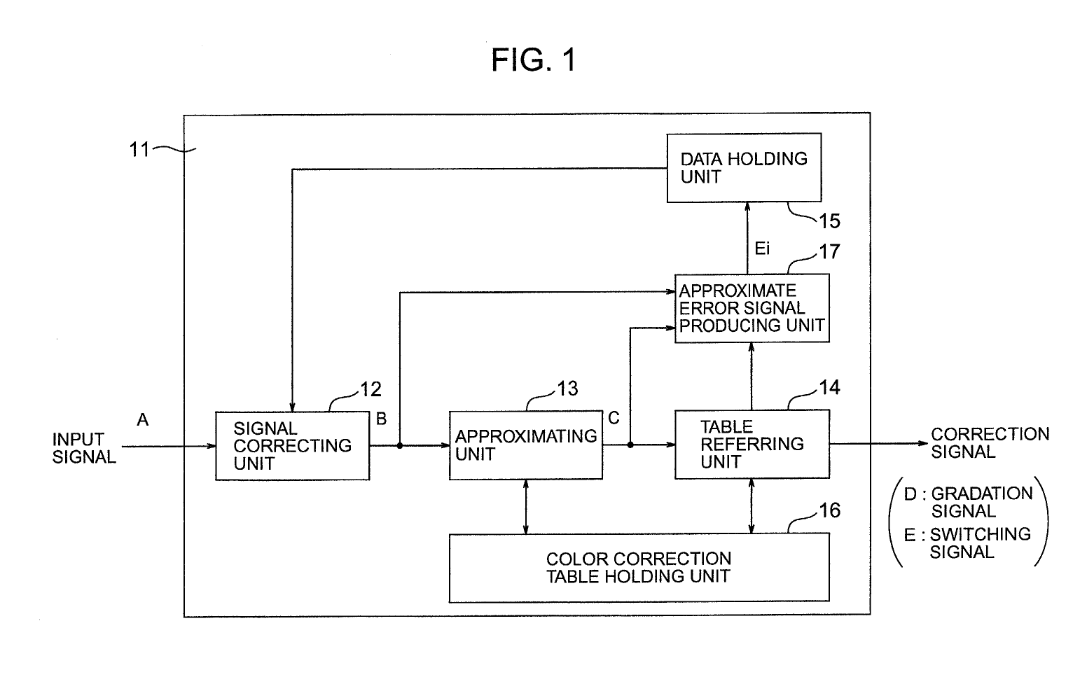

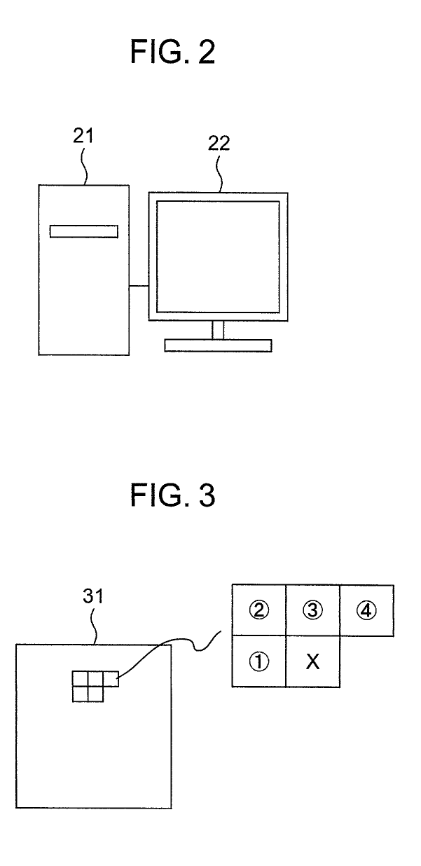

As illustratively shown in FIG. 2, an image processing apparatus according to the present invention can be mounted on a liquid crystal display apparatus 22 in which an image signal entered from an image signal input apparatus 21 such as, for example, a personal computer is displayed on a liquid crystal panel. As indicated in FIG. 1, an image processing apparatus 11 according to an embodiment mode of the present invention is arranged by employing a color correction table holding unit 16, a signal correcting unit 12, an approximating unit 13, an approximate error signal producing unit 17, a data holding unit 15, and also a table referring unit 14.

The color correction table holding unit 16 holds thereinto a color correction table. The signal correcting unit 12 corrects a color signal (input signal A) having, for instance, 8 bits (256 gradation numbers) per pixel which is sequentially entered into this signal correcting unit 12. The approximating unit 13 approximates an input signal (input signal B) which has been corrected by the signal correcting unit 12 to a coordinate value (input signal C) of the color correction table. The approximate error signal producing unit 17 calculates an approximate error signal (input signal Ei) based upon both the input signal B and the approximated result (input signal C). The data holding unit 15 stores thereinto the above-described approximate error in the unit of a line. The table referring circuit 14 outputs such correction data based upon the approximated result (input signal C) by referring to the color correction table, while the correction data is constituted by both gradation data (output signal D) and switching data (output signal E) used in a dither processing operation (which will be described later).

Detailed contents of the signal correcting unit 12, the approximating unit 13, the approximate error signal producing unit 17, and the table referring unit 14, which constitute the image processing unit 11, will now be explained as follows:

That is, the signal correcting unit 12 corrects the input signal A which is sequentially entered from the image signal input apparatus 21 based upon the following formula (1), and sequentially outputs the correction signal B to the approximating unit 13:

B=A+Σ(Ei×Fi) (1)

In this formula, the input signal A is a signal level of a pixel of interest corresponding to a subject to be processed, concretely speaking, a gradation value of the pixel of interest; the input signal Ei represents the approximate error produced in the approximating unit 13 (which will be discussed later), and is a signal level (initial value of “0”) of an approximate error signal with respect to a reference pixel read out from a memory of the data holding unit 15. Symbol “Fi” indicates a weight coefficient which is determined based upon a positional relationship between a pixel of interest and a reference pixel on an image. A “reference image” described in this embodiment corresponds to a plurality of peripheral pixels “1” to “4” which own a predetermined positional relationship with respect to a pixel of interest “X” on an image 31 as illustrated in FIG. 3. It should be noted that while considering a relationship of setting an image quality of an output image, both a total number of these reference pixels, and the positional relationship between the reference pixels and the pixel of interest may be preferably adjustable on a scene basis for example in connection with the value of the weight coefficient “Fi”.

Such a signal correcting unit 12 may be constituted by a weighting unit for multiplying error signals “E0” to “E4” of the reference pixels “1” to “4” by the weight coefficients “F0” to “F4”, and also, an adding unit for adding an output signal of this weighting unit to the input signal A.

The approximating unit 13 reads out a coordinate value (representative color signal) of the color correction table from the color correction table holding unit 16, compares this read representative color signal with the input signal B, executes an approximating operation of the compared value to the coordinate value, and then, outputs a coordinate value C of the color correction table to the table referring unit 14.

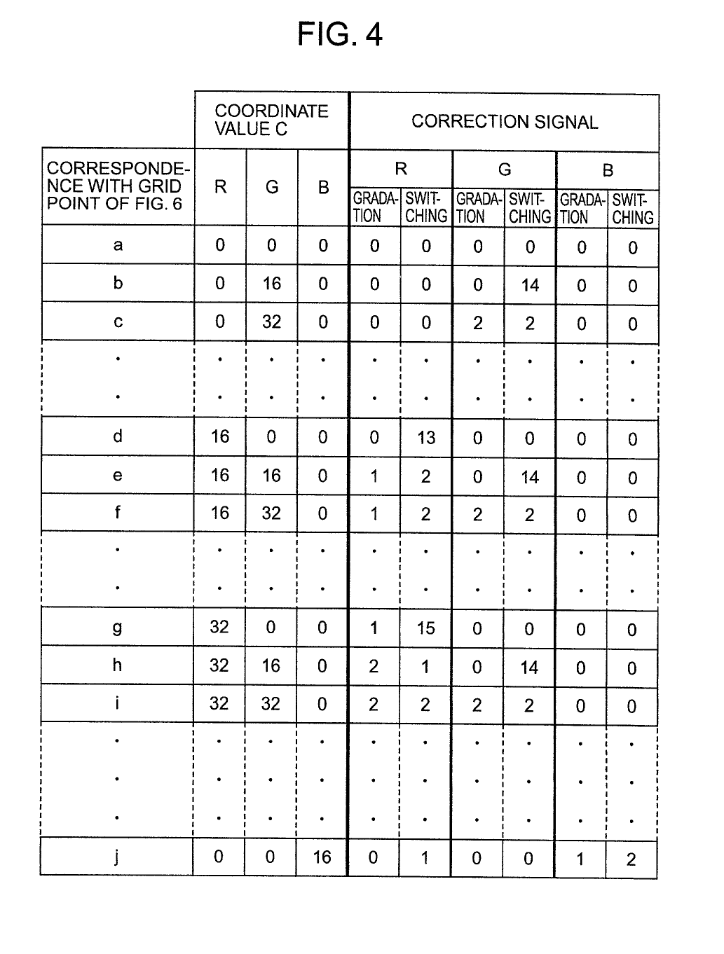

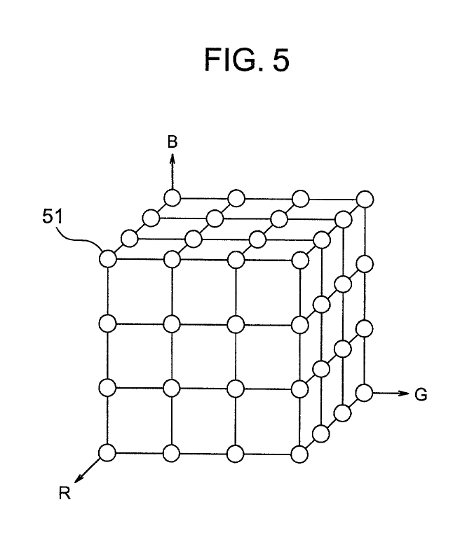

In this color correction table, the above-described information capable of correcting the chromaticity change caused by the optically rotating dispersion characteristic of the liquid crystal panel, and also color information which is wanted to be emphasized have been stored as correction data. Concretely speaking, as indicated in FIG. 4, the color correction table corresponds to such a conversion table indicative of a correspondence relationship between the coordinate value C capable of approximating the input signal B, and a correction signal (switching signal E for comparing gradation correction signal D with below-mentioned dither matrix). It should be understood that since the memory capacity of this color correction table will become large in order to have such a correspondence relationship for all of the input signals (for example, total number of color signals made by combinations of 8 bits of each of RGB colors is nearly equal to 16.70 million colors), this color correction table saves thereinto such a correspondence relationship as to only the representative color signals. One example of such methods for determining the representative color signals is given in FIG. 5. That is, while color space which is constituted by the respective color components (R, G, B etc.) of an input signal is subdivided in a grid shape, as to a grid point 51, a correction value of an output signal is stored in this color correction table by employing the input signal as a coordinate value.

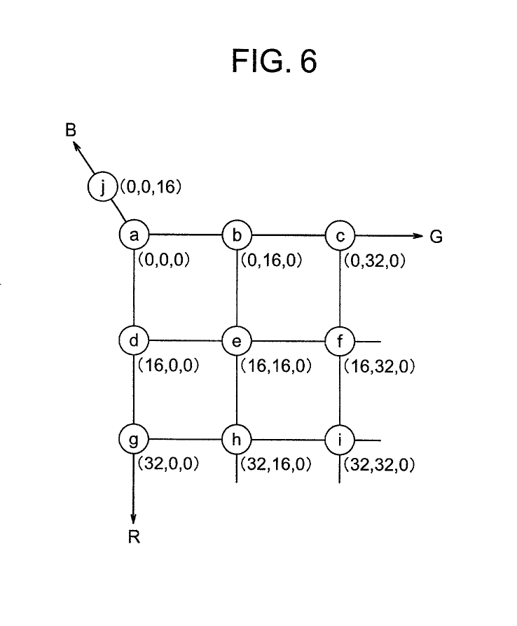

Referring now to a table arrangement of FIG. 6, the content of the conversion table shown in FIG. 6 will now be explained in detail. FIG. 6 indicates a portion of the color space indicated in FIG. 5. Since a two-dimensional color signal group constituted by both R signals and G signals is constituted every B signals, such color space constituted by these RGB signals may be expressed. In this example, since 8 bits (namely, 256 levels) of each of the RGB color signals are subdivided by 16, a total gradation number among the respective grid points becomes 16 levels as to each of the RGB colors. Color signals of a grid point “a” shown in FIG. 6 are R=0, G=0, B=0, whereas color signals of another grip point “b” are R=0, G=16, B=0. The color signals of such grid points correspond to the coordinate value C of the conversion table shown in FIG. 4, and the correction signals corresponding to this coordinate value C are registered in the conversion table. Both the gradation signal and the switching signal contained in the correction signal of FIG. 4 will be described in detail.

The above-described table formed by subdividing such color space in the grid shape corresponds to such a table that the input signal is equally subdivided so as to retrieve the coordinate value from the input signal. However, in a case that the correspondence relationship between the input signal and the output signal contains a large nonlinear characteristic, the gradation of the input signal after being converted may skip.

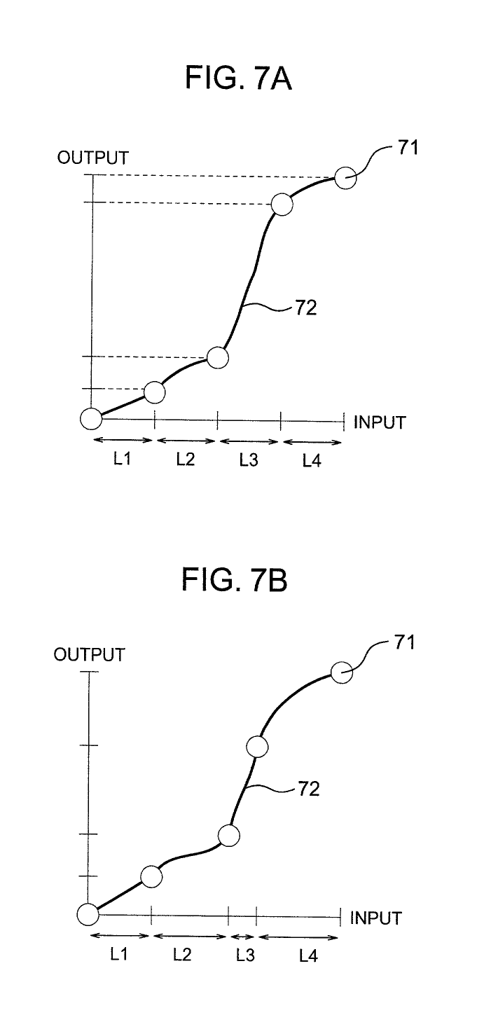

FIG. 7A and FIG. 7B illustratively represent an example of such a color correction table that gradation skipping may occur. For the sake of simple explanation, description is made of a signal conversion in which a mono-color indicative of gradation of a black/white signal is converted. FIG. 7A and FIG. 7B show such a color correction table that while an abscissa thereof indicates a coordinate of an input signal and an ordinate thereof shows a coordinate of an output signal, a correction curve 72 containing a large non-linear characteristic is subdivided into five grid points 71, and output data corresponding to the input signal after being corrected are stored.

FIG. 7A indicates such a color correction table that while a gradation level of an input signal is equally subdivided in such a manner (L1=L2=L3=L4), color correction data corresponding to subdivided points thereof are listed in a table form. In the case of this color correction table, since intervals among grid points at the output coordinate are largely fluctuated, relatively large differences are produced among data to be outputted. Although gradation in a local area is saved in an averaged gradation manner by the operation of the signal correcting circuit 12, since an error occurring per pixel is large, this error may become conspicuous in an image device having low resolution. To the contrary, as indicated in FIG. 7B, in a case that intervals among grid points at an output coordinate are made substantially equal to each other, although a retrieving process operation of the coordinates of the grid points at the input coordinate is required, it is possible to suppress such an error which may occur per pixel. As previously explained, since the input signal is not equally subdivided, the gradation skipping phenomenon caused by the non-linear characteristic of the correction curve 72 may be relaxed, or mitigated.

As to the judging method for approximating the input signal B to the coordinate value C of the color correction table, the following methods may be conceived, namely, a judging method in which the input signal B is approximated to a coordinate value of such a grid point which is located at the nearest position with respect to the this input signal B by utilizing such threshold values provided among the grid points of the color correction table; another judging method in which threshold values provided among the grid points are varied based upon a gradation value of the input signal B so as to approximate the input signal B to the coordinate value of the grid point; and also, another judging method in which the threshold values provided among the grid points are varied based upon a pixel position so as to approximate the input signal B to the coordinate value of the grid point. As to the judging method for approximating the input signal B to the coordinate value of the grid point, the present invention is not specifically limited thereto.

The approximate error signal producing unit 17 calculates an approximate error signal (input signal Ei) from both the input signal B and the approximated result (input signal C), and then, stores the calculated input signal Ei into the data holding unit 15.

The table referring unit 14 refers to the color correction table of the color correction table holding unit 16 based upon the coordinate value C derived from the approximating unit 13, and outputs a gradation signal D which is a correction signal corresponding to the coordinate value C, and a switching signal E used to be compared by a dither matrix (which will be discussed later).

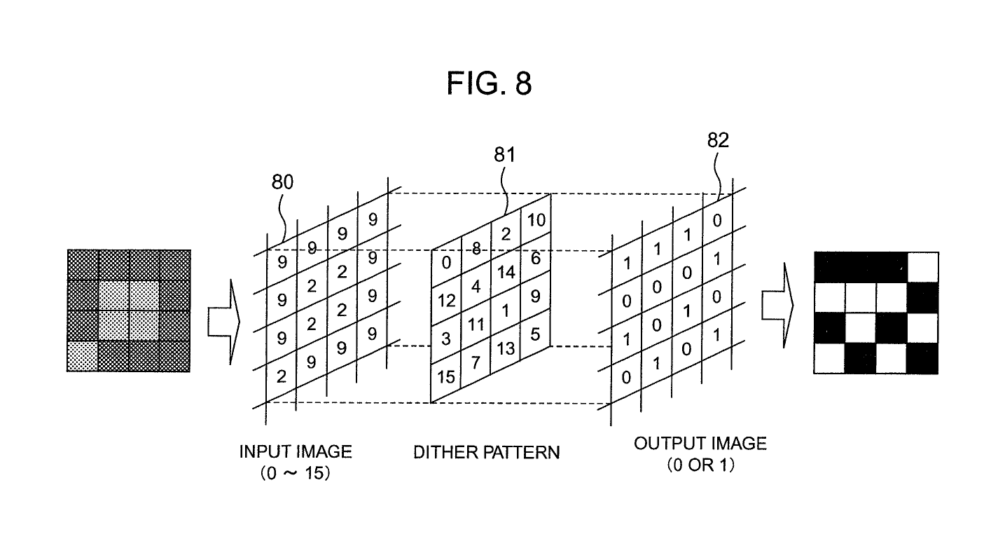

Both the gradation signal D and the switching signal E will now be explained. In an LCD and a printer, the following fact is known. That is, a total number of reproducible gradation is smaller than that of an input signal due to a restriction of an image device thereof. In this case, such a dither method is utilized by which reproducible gradation is manipulated at a local area of several pixels so as to produce a half-tone in a pseudo manner. The dither method corresponds to such a method for performing a gradation conversion by utilizing a two-dimensional threshold value array (=dither matrix). Since such a simple algorithm is realized in which gradation of an input pixel is compared with a threshold value corresponding to a position of this input pixel so as to determine ON/OFF of a dot, this dither method is suitable for a high speed operation. The dither operation will now be explained with reference to FIG. 8.

To execute the dither processing, such a matrix (which will be referred to as a “dither matrix” hereinafter) is utilized in which threshold values are arranged in a two-dimensional form, and a total number of these threshold values is equal to a total number of gradation used to represent pseudo-gradation. FIG. 8 illustratively indicates such a dither operation that an input image 80 having 16 gradation numbers (namely, 0 to 15) is represented as an output image 82 having 1 gradation number (namely, 0 or 1) in the pseudo-gradation representation manner, while utilizing a 4×4 dither matrix 81 having the array of threshold values “0” to “15.” In this dither method, while a coordinate of an input signal in an image region is related to a coordinate of the dither matrix 81, a threshold value corresponding to this coordinate is compared with a threshold value of the input signal. When the input signal is higher than the threshold value, “1” is outputted, whereas when the input signal is lower than the threshold value, “0” is outputted. As previously explained, since a mixture amount of the signals having the 2 gradation numbers is adjusted within the dither matrix 81, the pseudo-gradation representation having the 16-gradation numbers can be realized.

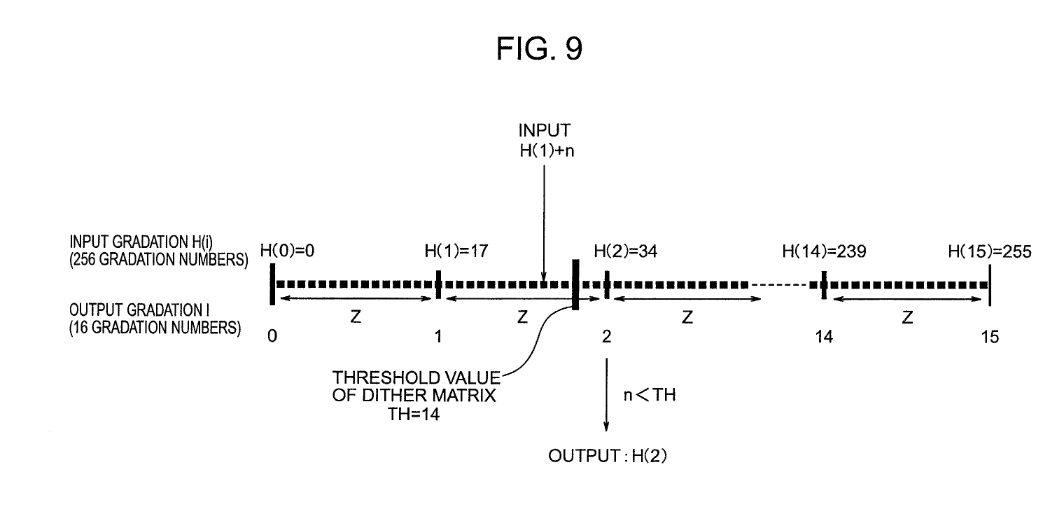

Similarly, the above-described dither operation may be applied to such image devices capable of outputting multi-gradation signals as an LCD and a current color printer in a similar manner to the above-described manner. In this case, since a mixture amount of outputtable gradation is adjusted, the pseudo-gradation representation of the multi-gradation output may be realized. This pseudo-gradation representation will now be explained as a concrete example with reference to FIG. 9.

In a case that, for example, an input signal is a 256-gradation signal and an output signal “i” is a 16-gradation signal, a gradation value H(i)=(i=0 to 15) of such an input signal which may be represented by the output signal is equal to 16 gradation values (namely, 0, 17, 34, −, 239, 255), and also, 240 pieces (region of Z) of gradation values (for example, 1 to 16, 18 to 33, etc.) of such input signals existing from the gradation value H(i) to the gradation value H(i+1) constitute subjects of the pseudo-gradation representations.

In a case that the pseudo-gradation representation is carried out, for instance, when an input signal is present between H(i) and H(i+1), such a dither matrix capable of adjusting a mixture amount of the gradation value “i” of the output signal corresponding to the gradation value H(i) and H(i+1) is utilized. In a case that an output signal is a 16-gradation signal, since 16 values are present between the gradation values H(i) and H(i+1), such a dither matrix may be used in which threshold values used to convert these 16 values into either the gradation value H(i) or the gradation value H(i+1). Concretely speaking, in such a case that the input signal=H(i)+n (n=0 to 16), the following dither matrix may be used. That is, in this dither matrix, threshold values (0 to 16) located around “n” are arranged in order that an output signal can be determined based upon the value of “n” in such a manner that when the threshold values of the dither matrix is larger than, or equal to “n”, it becomes the gradation value H(i), and when the threshold values of the dither matrix is any number other than “n”, it becomes the gradation value H(i+1). As a result, the pseudo-gradation representation of the multi-gradation output can be realized.

In this case, the gradation signal of the correction signal, indicates “H(i)” and the switching signal denotes “n”, which are stored in the conversion table shown in FIG. 4. In such a case that a total gradation number which can be represented in an image device of an output is equal to 2^{N}, separation between “H(i)” and “n” may be carried out by way of a bit-shift operation, or a logical AND operation. However, in an exceptional case, for example, a total number of reproducible gradation is equal to 10-gradation, a separation between the gradation values H(i) and “n” may become complex. However, if both “H(i)” and “n” are saved as separate data, then such a decision may be made as to whether the gradation data H(i) outputted from the table referring unit is directly outputted, or H(i)+1 is outputted by comparing the switching data “n” outputted from the table referring unit with the threshold value of the dither matrix without the separation. It should also be noted that in such a case that a capacity of table data is limited, while both a gradation signal and a switching signal are packaged into one piece of data (for example, 2-byte data) and this packaged data is stored in the table referring unit, the above-explained separation between the gradation signal and the switching signal is carried out after referring to the table so that both the gradation signal and the switching signal may be obtained.

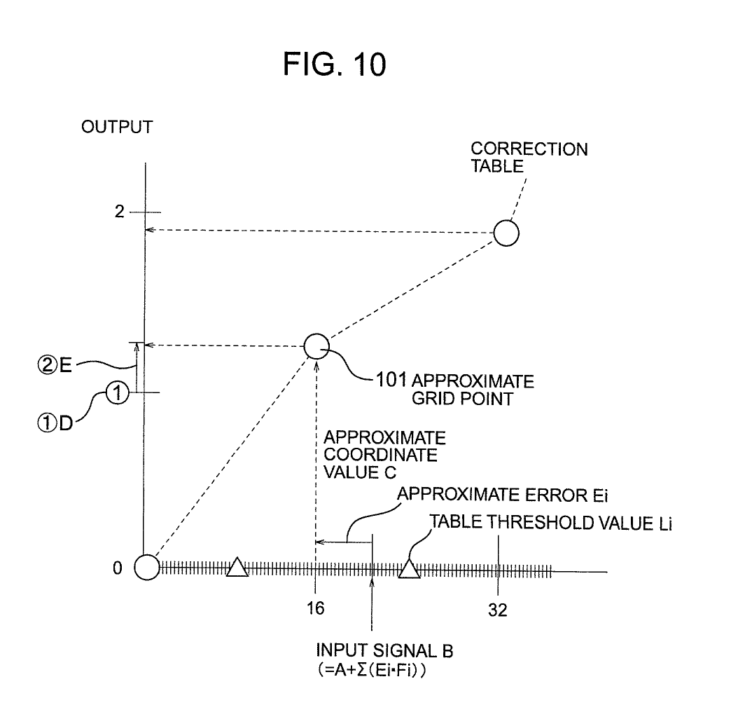

Referring now to FIG. 10, a description will be made of the above-described conversion stages from the input signal A to the output signals D and E by this image processing apparatus 11. This graph graphically explains that 8-bit monochromatic data is converted into 4-bit monochromatic data by this image processing apparatus 11. An abscissa of this graph shows a gradation level of an input signal, and an ordinate indicates a gradation level of an output signal, while correction data corresponding to input gradation values of 16, 32, - - - , are stored in a correction table.

Concretely speaking, the 4-bit data converted by this image processing apparatus 11 corresponds to gradation data D and switching data E used to execute the dither process operation, while this gradation data D is obtained when the correction data corresponding to the input gradation values 15, 32, - - - , are converted into 4-bit correction data. In a case that a grid point 101 is exemplified, numeral “1” shows the gradation data D and number “2” indicates the switching data E. A grid point coordinate (16) is detected by using a threshold value “Li” between grid points and is approximated, while this grid point coordinate C(16) is located at the nearest place with respect to the input signal B which is obtained by correcting the input signal A by employing the signal connecting circuit 12. An approximate error “Ei” produced by the approximation is stored in the memory. Also, both the gradation data D and the switching data E, which correspond to the approximated coordinate value C are outputted by referring to the correction table.

As previously described in detail, in accordance with this image processing apparatus 11, the color converting operation which would conventionally require the very complex calculation operations can be realized in such a manner that the compressed signal is corrected by utilizing the approximating operation and the approximate error to the color signals corresponding to the color correction table. As a consequence, both the processing time and the circuit scale can be reduced. Furthermore, since the correction data corresponding to the representative color signals is constituted by the switching data used to compare the threshold value of the gradation data with the threshold value of the dither matrix and then this correction data is stored in the color correction table, the separating operation from the input signal to the switching data used to execute the threshold value comparison in the dither operation can be reduced. Also, the dither operation with respect to the data outputted from this image processing apparatus can be carried out at a high speed. As to both the color approximation and the addition to the unprocessed signal, while the gradation conversion errors may occur, as viewed in the unit of pixel, these gradation conversion errors are held in an average manner at the local area. It should also be noted that even such a representation made by a dither pattern is not conspicuous if resolution of an output device and a total gradation number of this output device are high, for example, the total gradation number is larger than, or equal to 16 and the resolution is higher than, or equal to 200 PPI.

It should also be understood that while the calculation operation of the approximate error exemplified in this embodiment mode may merely constitute one example, the calculation operation of the approximate error by the approximating circuit employed in this image processing apparatus is not limited to the above example. For example, when a reference pixel is limited to such pixels located adjacent to each other on the same line, errors are not required to be stored in the unit of line, so that the data holding unit 15 may be no longer required.

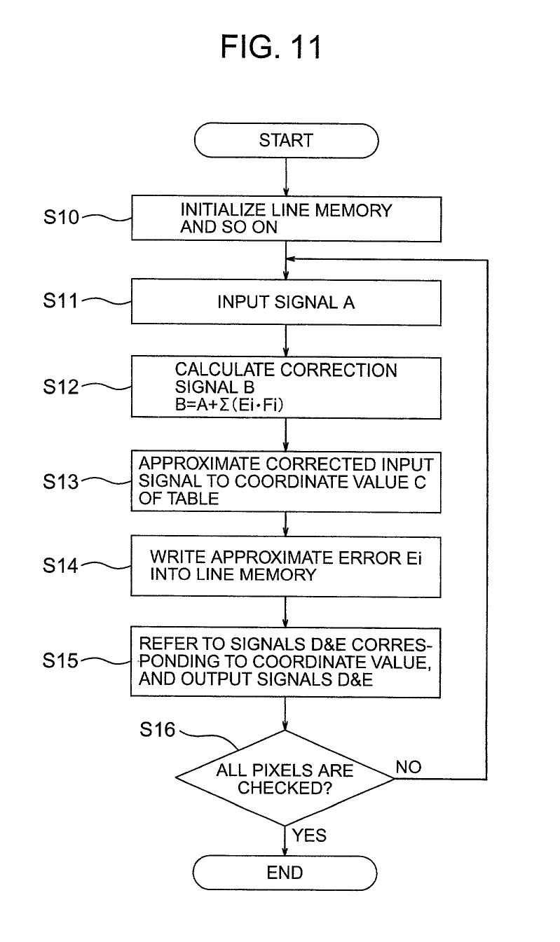

As indicated in FIG. 11, the above-described functions of this image processing apparatus 11 may also be realized by way of software. In other words, as will be explained later, a processor may execute signal processing similar to that of this image processing apparatus by utilizing both software and the conversion table stored in a memory.

First, the processor initializes the memory which stores thereinto approximate errors (step S10). Thereafter, the processor executes such operations defined from the below-mentioned steps S11 up to S15 with respect to all of pixels on a screen, respectively. When the processor receives an input signal A of one pixel (step S11), the processor reads out approximate error value “Ei” as to reference pixels related to this one pixel, and then, corrects the input signal A in accordance with the above-described formula (1) (step S12). Then, the correction signal B obtained from this correction is approximated to a coordinate value of the input signal described in the conversion table (step S13). The processor calculates an approximate error “Ei” produced by the approximation, and then, stores this calculated approximate error Ei into the memory (step S14). Next, the processor reads out both gradation data D and switching data E, which correspond to the coordinate value of the conversion table used to approximate the input signal, and then, outputs the read gradation data D and the switching data E (step S15). Then, the processor judges as to whether or not a pixel of interest is the last pixel on the screen, and accomplishes the process operation when this pixel of interest is the last pixel (step S16). In other cases, the processor repeatedly executes the operations subsequent to the step S11. As previously explained, even when the signal processing of this signal processing apparatus is realized by way of such software, the complex calculation operation required in the conventional color converting operation is no longer required, so that this image processing may be approximately carried out at a high speed.

Subsequently, description will be made of such an image processing apparatus in which a dither processing unit is assembled therein, and colors of an input signal and an output signal are selected to be three colors. Various embodiments as to a liquid crystal display apparatus having an analog interface and a digital interface, the time-axis division display apparatus, and a printer apparatus while using this image processing apparatus thereinto will be explained respectively.

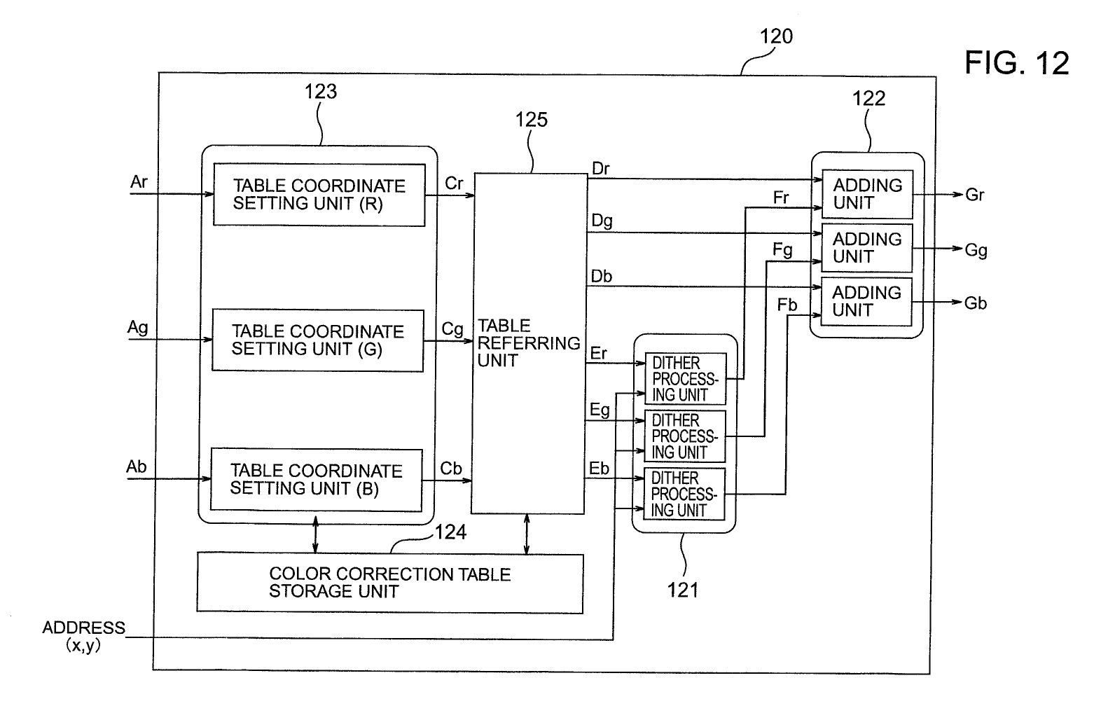

FIG. 12 is a functional block diagram of an image processing apparatus 120 in which both a dither processing unit 121 and an adding unit 122 are assembled. In this embodiment, colors of both an input signal and an output signal are selected to be three colors, respectively. Since three blocks of the signal correcting units 12, the approximating unit 13, the approximate error signal producing units 17, and also the data holding units 15, which are present from the input signal up to the table reference, are operable in a similar manner as to the three colors, these three blocks are combined with each other to be set as table coordinate setting units 93 for the respective colors. Next, operations of this image processing apparatus will be explained as follows:

Upon receipt of input signals Ar, Ag, and Ab of one pixel, the table coordinate setting units 123 of the respective colors output typical color signals Cr, Cg, Cb of color correction tables. Next, the table referring unit 125 reads out gradation data Dr, Dg, Db and switching data Er, Eg, Eb, which correspond to the coordinate values Cr, Cg, Cb, from a color correction table storage unit 124, and then, outputs these gradation data Dr, Dg, Db and these switching data Er, Eg, Eb. Up to the above-explained operations, this image processing apparatus 120 is operated in a similar manner to that of the image processing apparatus shown in FIG. 1.

The dither processing unit 121 compares the switching signals Ef, Eg, Eb outputted from the table referring unit 125 with the dither matrix to output ON/OFF signals (either “0” signal or “1” signal) Fr, Fg, Fb to the adding unit 122. The adding unit 12 adds the ON/OFF signals Fr, Fg, Fb derived from the dither processing unit 121 to the gradation data Dr, Dg, Db read out from the table referring unit 125 to thereby output gradation data Gr, Gb, Gg.

As previously explained, in accordance with the image processing apparatus 120 shown in FIG. 12, the color converting operation which would conventionally require the very complex calculation operations can be realized in such a manner that the unprocessed signal is corrected by utilizing the approximating operation and the approximate error to the color signals corresponding to the color correction table. As a consequence, both the processing time and the circuit scale can be reduced. Furthermore, since the correction data corresponding to the representative color signals is constituted by the switching data used to compare the threshold value of the gradation data with the threshold value of the dither matrix and then this correction data is stored in the color correction table, the separation operation from the input signal to the switching data used to execute the threshold value comparison in the dither operation can be reduced. Also, the dither process operation can be carried out at a high speed. Next, an example of an image device which mounts thereon the image processing apparatus of the present invention will now be explained as follows:

[Embodiment 1]

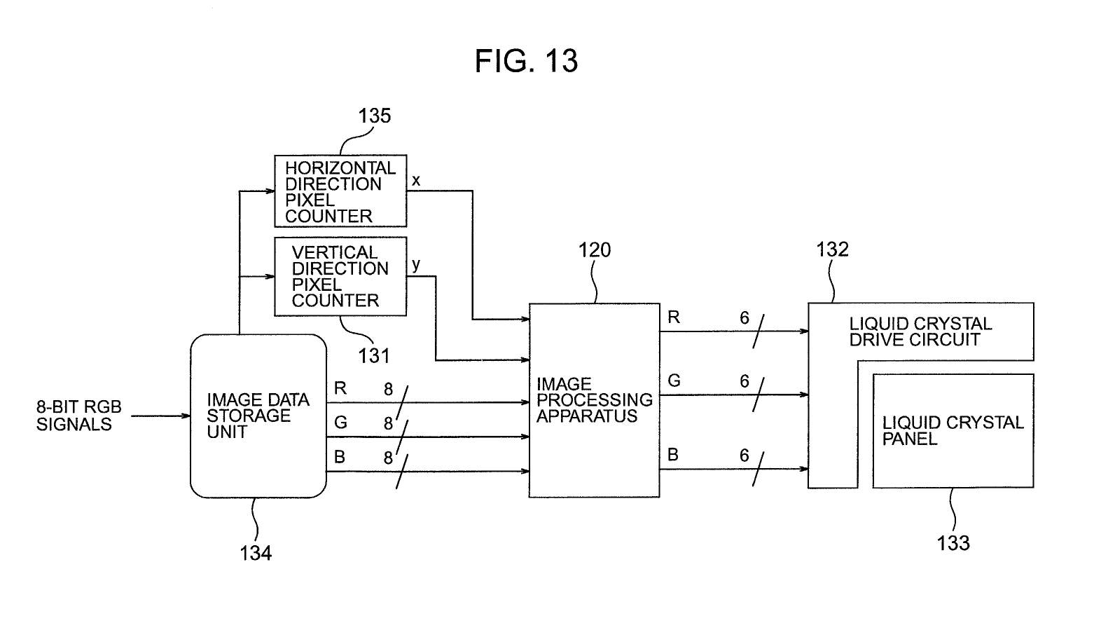

FIG. 13 schematically indicates an example of a liquid crystal display apparatus equipped with a digital interface, and a digital drive circuit, while the image processing apparatus of the present invention is mounted thereon.

In addition to the image processing apparatus 120 (see FIG. 12) according to the present invention, this liquid crystal display apparatus is provided with an image data storage unit 134, a horizontal direction pixel counter 135, a vertical direction pixel counter 131, a liquid crystal panel 133, and a digital interface liquid cristal drive circuit 132. The image data storage unit 134 stores thereinto 8-bit RGB image data. The horizontal direction pixel counter 135 counts a pixel clock along the horizontal direction in response to such timing at which a signal is outputted from the image data storage unit 134, converts this counted pixel clock into a coordinate value of a dither matrix along the horizontal direction, and then, supplies this converted coordinate value to the image processing apparatus 120. The vertical direction pixel counter 131 counts a pixel clock along the vertical direction, converts the counted pixel clock into a coordinate value of the dither matrix along the vertical direction, and then, supplies the converted coordinate value to the image processing apparatus 120. The liquid crystal panel 133 displays thereon each of 6-bit RGB data. Also, the digital interface liquid crystal drive circuit 132 displays digital data outputted from the image processing apparatus 120 on the above-described liquid crystal panel 133. It should also be noted that such data capable of correcting a change in color balances, which is caused by the optically rotating dispersion characteristic specific to the liquid crystal panel, have been stored in the correction table employed in the image processing apparatus 120.

Each of the 8-bit RGB digital data outputted from the image data storage unit 134 is converted into 6-bit gradation data by the image processing apparatus 120. The dither circuit 121 employed in the image processing apparatus 120 compares a threshold value of the dither matrix corresponding to a count value “x” of the horizontal direction pixel counter 135 with another threshold value of this dither matrix corresponding to another value “y” of the vertical direction pixel counter 131. The gradation data outputted from the image processing apparatus 120 is outputted to the liquid crystal drive circuit 132, and an image is displayed on the liquid crystal panel 133. As a result, in the digital interface of the liquid crystal display apparatus, such dither results obtained by executing the correcting operation of the color characteristic and also the color emphasis processing of the liquid crystal panel can be outputted at a high speed.

[Embodiment 2]

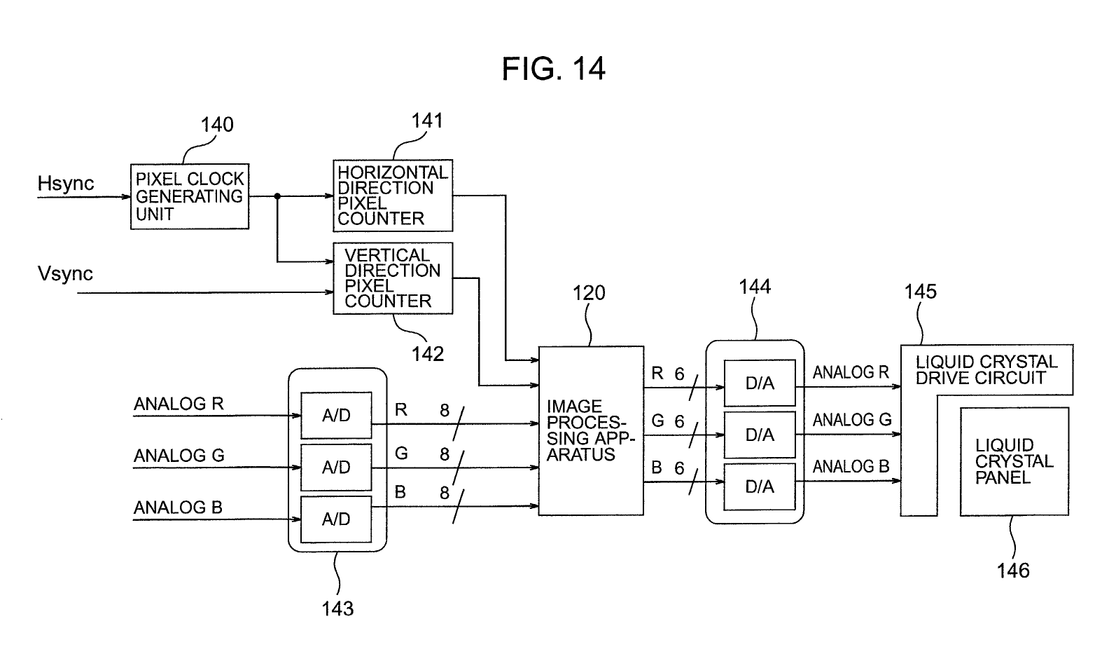

FIG. 14 schematically represents an example of such a liquid crystal display apparatus equipped with an analog interface and an analog drive circuit, while the image processing apparatus of present invention is mounted.

In addition to the image processing apparatus 120 of the present invention, this liquid crystal display apparatus is provided with an A/D converter 143, a D/A converter 144, a liquid crystal drive circuit 145 of an analog interface, a liquid crystal panel 146, a pixel clock generator 140, a horizontal direction pixel counter 141, and also a vertical direction pixel counter 142.

The A/D converter 143 converts an entered analog signal into an 8-bit digital signal. The D/A converter 144 converts this 8-bit digital signal into an analog signal corresponding thereto. The pixel clock generator 140 generates a pixel clock at a sampling frequency of the liquid crystal drive circuit 145 in synchronism with an entered horizontal synchronization signal. The horizontal direction pixel counter 141 converts an entered pixel clock into a coordinate value of a dither matrix along the horizontal direction, and then, supplies this converted coordinate value to the dither circuit 121 employed in the image processing apparatus 120. Also, the vertical direction pixel counter 142 converts a pixel clock along the vertical direction into a coordinate value of the dither matrix along the vertical direction in response to both the horizontal and vertical synchronization signals, and then, supplies the converted coordinate value to the dither circuit 121 employed in the image processing apparatus 120.

An analog signal inputted from a personal computer or the like is converted into an 8-bit digital signal by the A/D converter 143, and the signal generated from the pixel clock generator 140 is received by the horizontal direction pixel counter 141, so that a coordinate value of the dither matrix along the horizontal direction, corresponding to the input signal, is produced. Also, the signal generated from the pixel clock generator 140 is received by the vertical direction pixel counter 142, so that a coordinate value of the dither matrix along the vertical direction, which corresponds to the input signal, is produced. While using the A/D-converted digital data and also the data of the coordinate value of the dither matrix, the input signal is converted into 6-bit gradation data by the image processing apparatus 120. The digital data derived from the image processing apparatus 120 is converted into an analog signal, and then, this analog signal is outputted to the liquid crystal drive circuit 145 so as to display the image thereof on the liquid crystal panel 146. As a consequence, in the liquid crystal display apparatus equipped with the analog interface, such dither results obtained by executing the correcting process operation of the color characteristic and also the color emphasis operation of the liquid crystal panel can be outputted at a high speed.

[Embodiment 3]

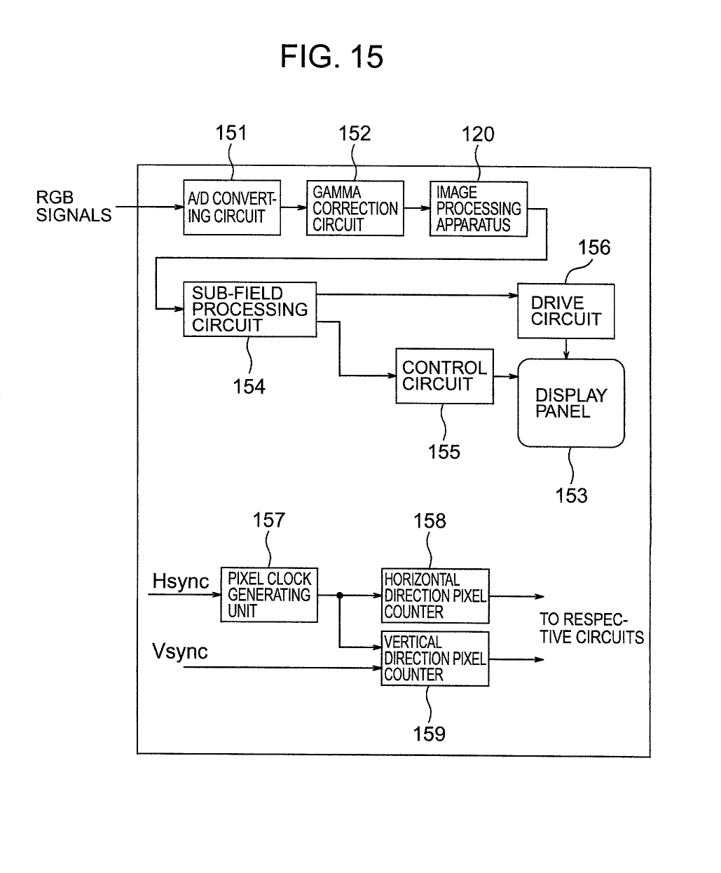

FIG. 15 schematically indicates an example in which the image processing apparatus of the present invention is mounted on such a display device as an EL panel and a plasma display, which performs a gradation display by employing a plurality of sub-fields.

In an image display apparatus equipped with a display panel such as a plasma display panel (PDP) capable of performing light emission in a binary manner, a sub-field method is employed, by which a moving image having a half-tone is displayed by temporally overlapping a plurality of binary images with each other, while these binary images are weighted respectively. In this sub-field method, while 1 field is temporally subdivided into a plurality of sub-fields, the respective sub-fields are separately weighted. The weights of these sub-field correspond to light emission amounts when the respective sub-fields are turned ON. In other words, while each to the sub-fields owns a preselected light emission time as a luminance weight, a total of the weights of the light-emitting sub-fields corresponds to gradation of luminance to be displayed.

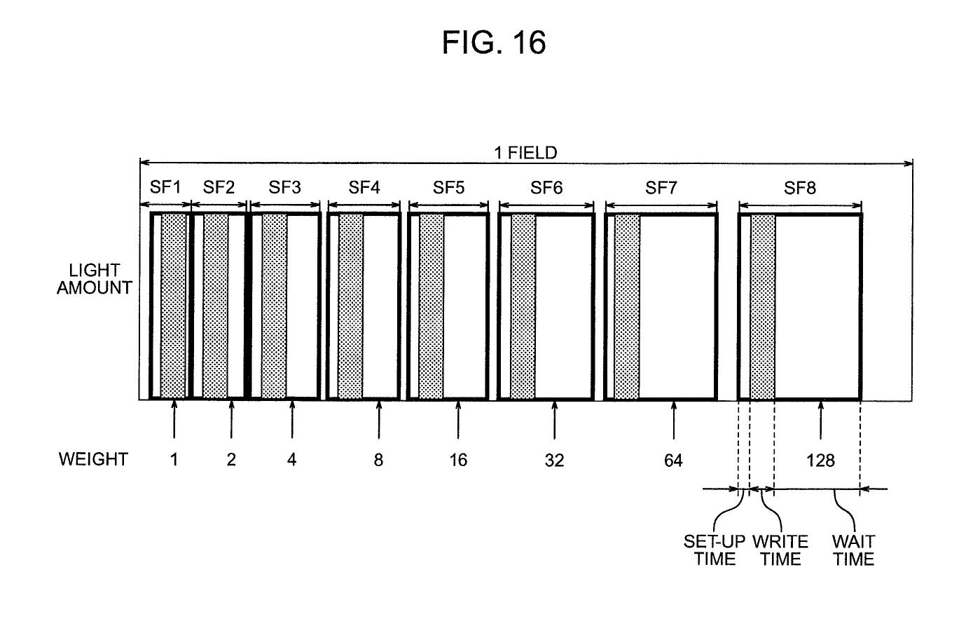

FIG. 16 represents a temporal relationship among the respective sub-fields in 1 field. An abscissa indicates time, and an ordinate shows a light amount. In this embodiment, 1 field is subdivided into 8 sub-fields defined from a sub-field (SF1) to a sub-field (SF8), and the respective sub-fields own luminance weights of 1, 2, 4, 8, 16, 32, 64, and 128. As to each of these 8 sub-fields “SF1” to “SF8”, predetermined control is carried out in set-up time “Setup”, in write time during which either ON-data or OFF-data is written every pixel of a panel screen, and in sustain time “Wait” during which pixels into which the ON-data are written are turned ON one time during the write time, respectively. The light emission of the sub-fields are sequentially performed from the sub-field “SF1” to the sub-field “SF8”. In the example shown in FIG. 16, since these sub-fields are combined with each other in a various manner so as to execute the light emission, 256 stages of gradation levels defined form “0” to “256” can be represented. For instance, a gradation level 21 may be represented by performing the light emission within the sub-field “SF1”, the sub-field “SF3”, and the sub-field “SF5”. As previously explained, in accordance with the sub-field method, while such sub-fields used to achieve desirable gradation are selected from a plurality of sub-fields which are obtained by temporally subdividing 1 field, the light emission are carried out within these selected sub-fields, so that the half-tone gradation can be represented.

The display apparatus shown in FIG. 15 is arranged by an A/D converting circuit 151, a gamma correction circuit 152, the image processing apparatus 120 of the present invention, a sub-field processing circuit 154, a control circuit 155, a drive circuit 156, a pixel clock generating circuit 157, a horizontal pixel counter 158, and a vertical pixel counter 159. The A/D converting circuit 151 converts analog RGB signals into digital RGB data. The gamma correction circuit 152 corrects gamma characteristics of the RGB data. Then, the sub-field processing circuit 154 converts gradation data supplied from the image processing apparatus 120 into field information made of plural bits, which correspond to sub-fields. This sub-field information corresponds to a signal for determining as to whether or not a light emission is performed in a sub-field. Then, the sub-field processing circuit 154 determines a total number of sustain pulses derived during the light emission sustain time period based upon the converted field information. The control circuit 155 controls light emission amounts of the respective pixels constituting the display panel 153 so as to display gradation on this display panel 153. The pixel clock generating circuit 157 generates a pixel clock at a sampling frequency of the drive circuit 156 in synchronization with an entered horizontal synchronization signal. The horizontal pixel counter 158 converts the entered pixel clock into a coordinate value of a dither matrix along the horizontal direction, and then, supplies the converted coordinate value of the dither matrix to the dither circuit 121 employed in the image processing apparatus 120. Also, the vertical pixel counter 159 converts a pixel clock along the vertical direction into a coordinate value of the dither matrix along the vertical direction in synchronization with both the horizontal synchronization signal and a vertical synchronization signal, and then supplies the converted coordinate value to the dither circuit 121 employed in the image processing apparatus 120. As a result, in such a display apparatus using the sub-field method, the dither results which are obtained by correcting the color characteristic of the display panel, and also by executing the color emphasis process operation thereof, can be outputted at a high speed.

[Embodiment 4]

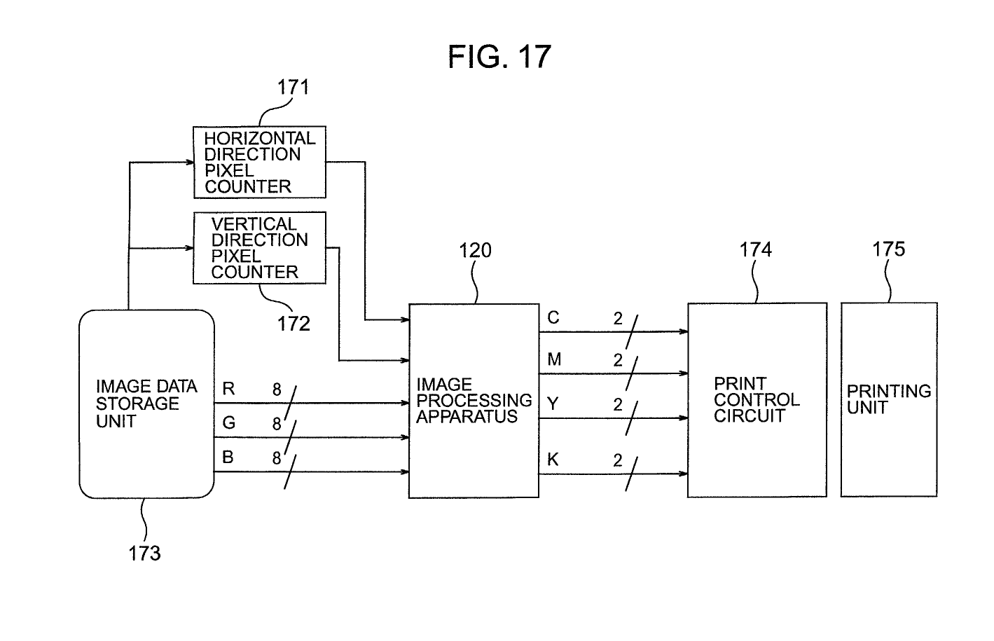

FIG. 17 schematically indicates another example in which the image processing apparatus of the present invention is mounted on a printer apparatus capable of representing 2-bit CMYK gradation.

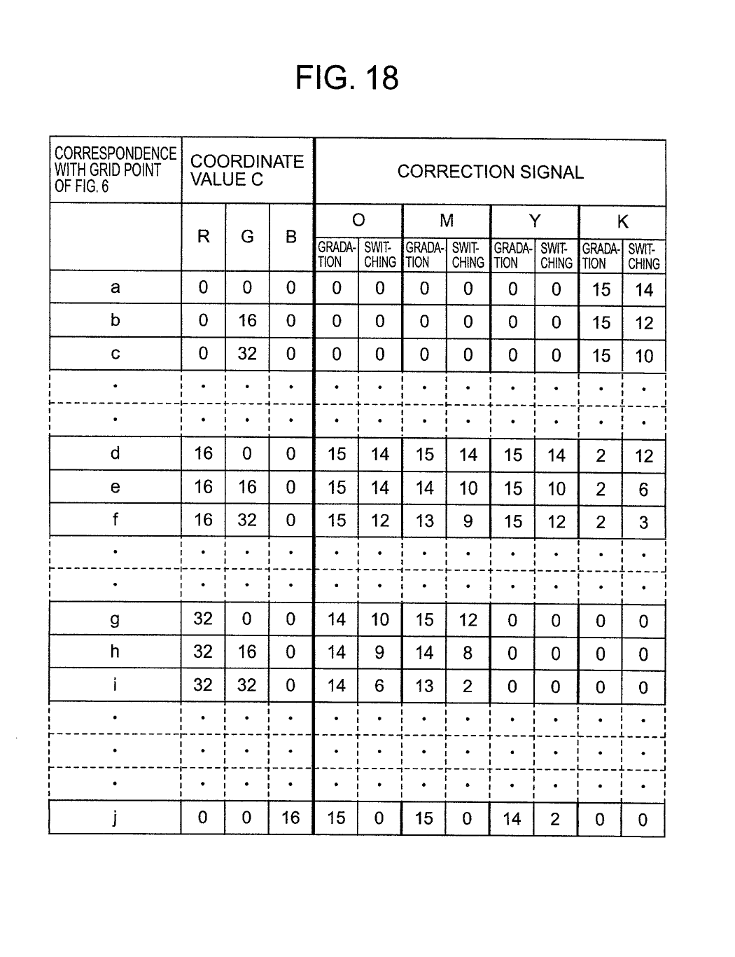

In this case, within the color correction table employed in the image processing apparatus, correction data “D” and “E” of CMYK corresponding to coordinate values “C” of RGB are stored in such a manner as shown in FIG. 18 with respect to such correction data which are used to correct distortion of color hue lines, which is caused by a spectral characteristic of ink, and also so as to reduce ink amounts. As explained above, in such a case that a total number of input signals is different from a total number of output signals, since a plurality of correction signals, the total number of which is equal to the total number of output signals, are stored in the correction table, the correction operation can be carried out, while these output signals correspond to the coordinate values “C” constructed of the input signals.

In addition to the image processing apparatus 120 of the present invention, this printer apparatus is arranged by an image data storage unit 173, a horizontal direction pixel counter 171, a vertical direction pixel counter 172, a print control circuit 174, and a printing unit 175. The image data storage unit 173 stores thereinto 8-bit RGB image data. The horizontal direction pixel counter 171 counts a pixel clock along the horizontal direction at such timing when a signal is outputted from the image data storage unit 17 so as to convert the counted pixel clock into a coordinate value of a dither matrix along the horizontal direction, and then supplies the converted coordinate value into the image processing apparatus 120. The print control circuit 174 executes a print control operation in response to 2-bit CMYK data of color ink signals which correspond to the RGB signals. Then, the printing unit 175 performs the printing operation. It should also be noted that while the correction values of the three colors CMY are stored in this correction table, the three colors RGB may be inputted and the three colors CMY may be outputted. As a consequence, this printer apparatus can output such dither results at a high speed, which are obtained by correcting the distortion of the color hue lines caused by the spectral characteristic of the ink, and also by reducing the ink amounts.

It should also be understood that the above-described image processing operation by such a printer apparatus may be executed by software (see FIG. 11) installed in a personal computer (not shown) which is connected to this printer apparatus. In this alternative case, while the image processing operation is carried out by this personal computer, either output gradation data or compression data of the gradation data is transferred to the printer apparatus. When the supplied data corresponds to the compression data, the printer apparatus expands this compression data to produce gradation data, and performs printing operation in response to this expanded gradation data.

[Discrimination of Image Data Outputted by the Present Invention]

In this case, a discrimination method will now be explained. That is, in accordance with this discrimination method, a personal computer, an image processing processor, and an apparatus having an image processing function such as ASIC and FPGA, into which both the image processing apparatus and the image processing method of the present invention have been applied, may be discriminated from each other based upon image data outputted from the above-explained apparatus.

In accordance with the present invention, since the entered color signal is approximated to the color signal of the color correction table and then the approximate error which is produced by this approximating process operation is propagated, such specific low-frequency noise is produced in the resulting image data, while such specific low-frequency noise would not be produced in the conventional color signal converting method described above. This specific low-frequency noise is similar to such a noise as is produced in either an error diffusion method or an averaged error minimizing method, which are utilized in a case that a total gradation number of input data is converted into a total printable gradation number of a printer. This specific low-frequency noise will also be referred to as a chain-shaped texture. Referring now to FIG. 10, a reason why this low-frequency noise is produced will be explained.

The conversion stages of both the image processing apparatus and the image processing method, according to the present invention, shown in FIG. 10 exemplify such an example that both the image data A and the input signal B (A+Σ(Ei×Fi)) which are produced by using the previously-stored approximate error Σ(Ei×Fi) are approximated to the approximate grid point position “16” of the color correction table, the approximate error Ei (=B−16) which is produced by this approximate operation is employed as a subject of the propagation operation to the unprocessed data. The reason why the above-explained low-frequency noise is produced will now be explained by utilizing FIG. 10.

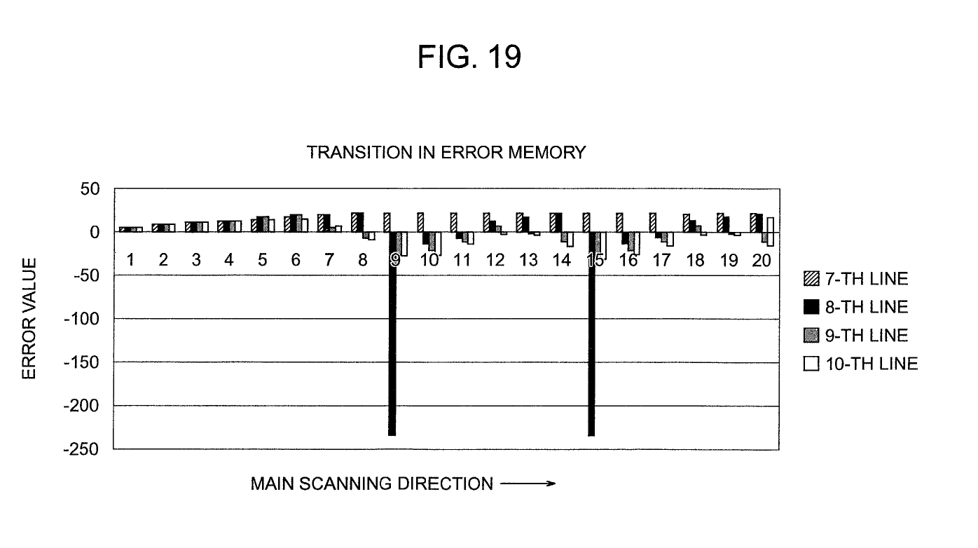

In such a case that an image is processed by way of either the image processing apparatus or the image processing method according to the present invention, while an image data size of this image is defined by transverse 50 pixels×longitudinal 50 pixels and an image data value (A) is uniformly “17”, the approximate error Ei stored in the data holding unit 15 may be transferred as indicated in FIG. 19. In FIG. 19, an abscissa indicates a pixel along a transverse pixel direction, an ordinate shows a stored error amount Ei of this pixel position, namely indicates such stored errors occurred in a 7-th line up to a 10-th line. When the input signal B is produced, both the image data value “17” and the approximate error Ei are utilized, the approximate error Ei is produced at the previously processed pixel positions “1”, “2”, “3”, “4” as illustrated in FIG. 3. Since the input signal B is smaller than the table threshold value “Li” just after this operation is commenced, this input signal B is approximated to a value of “16” which is smaller than the input signal B, and then (+) approximate error Ei is stored at a pixel position “X” to be processed.

When the process is advanced, the approximate error Ei is increased, the input signal B exceeds the table threshold value Li, and thus, this input signal B is approximated to a value “32” larger than the input signal B. In this case, since the input signal B is approximated to the larger value than this input signal B, (−) approximate error Ei is stored. However, the adverse influence caused by this (−) approximate error Ei may be given both when pixels located at a right side adjacent to the pixel are processed and also when pixels contained in the next line are processed. Precisely speaking, although the pixels subsequent to the right-sided adjoining pixel are adversely influenced by the erroneous propagation, as indicated in FIG. 3, since a large number of the approximate error values higher than, or equal to 1 line are utilized, the input signal B of “32” is produced in a constant time period.

However, while the pixels of the next line are processed, since a large number of (−) approximate error values are utilized which are produced by generating the above-described “32” having the constant time period, the input signal B does not reach the table threshold value Li under which “32” can be hardly produced.

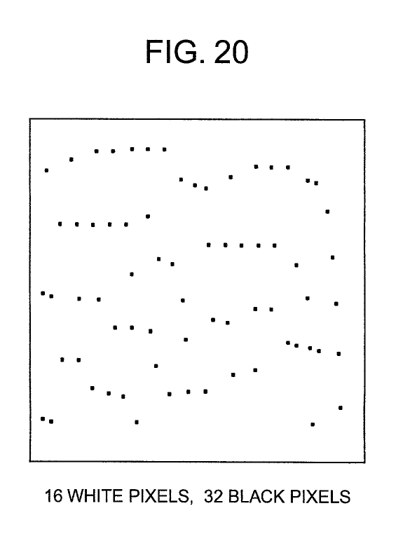

FIG. 20 illustratively indicates that a signal of an approximate coordinate value “C” is processed in an image data form. For the sake of clear discrimination, “16” is indicated as a white pixel, and “32” is shown as a black pixel. Although the image data value A (=17) is represented by both 16 and 32, the following fact may be revealed. That is, when a certain line is observed, “32” is produced in a periodic manner, but substantially no “32” is produced in another line. As previously explained, such an image which may be seen in such a way that the pixels having the same signal values are arranged will be referred to as “low-frequency noise.”

In accordance with the image processing apparatus and the image processing method of the present invention, while the color correction values corresponding to the produced “16” and “32” are generated, this relationship may be maintained even in these color correction values. As to the low-frequency noise, the below-mentioned solution methods may be proposed, but this low-frequency noise cannot be completely canceled. As these solution methods, weight coefficients and/or the total number of reference pixels are changed. Alternatively, the table threshold values may be changed at random.

Such a low-frequency noise may not become conspicuous, since the image display apparatus and the image output apparatus are made in high definition modes. However, this low frequency noise may be recognized if such an instrument, or an apparatus is used by which the image data is enlarged, for instance, a loupe, or an image magnifying lens. Thus, the personal computer, the image processing processor, and the apparatus having the image processing function such as ASIC and FPGA, to which both the image processing apparatus and the image processing method of the present invention are applied, can be readily discriminated from each other based upon the image data outputted from the above-described apparatus.

In such a case that an image which is inputted into the personal computer can be designated, the image processing processor, and the apparatus having the image processing function such as ASIC and FPGA, gradation images each having gradation values of 0, 1, 2, - - - , 255 may be utilized. Since a gradation image surely contains a signal value used to an approximate error, the above-described low-frequency is generated at this position. Therefore, if the entire portion of the image data which is outputted from the appratus having the image processing function is observed, the applications of the image processing apparatus and the image processing method according to the present invention may be discriminated.

It should be further understood by those skilled in the art that the foregoing description has been made on embodiments of the invention and that various changes and modifications may be made in the invention without departing from the spirit of the invention and the scope of the appended claims.

What is claimed is:

1. An image processing apparatus in which a color correction table containing a correspondence relationship between an input color signal and an output color signal in a table form is utilized in a conversion operation between color signals, comprising:
a color correction table holding unit for storing thereinto a predetermined discrete input color signal and a color correction table which contains a correspondence relationship between said predetermined discrete input color signal and an output color signal in a table form;
an approximating unit for approximating an entered input signal to said discrete input color signal of the color correction table to thereby output the approximated color signal;
an approximate error producing unit for calculating an approximate error based upon both the color signal inputted into the approximating unit and the color signal outputted from the approximating unit;
an approximate error holding unit for holding thereinto the approximate error calculated by said approximate error producing unit;
a signal correcting unit for correcting the color signal entered into said approximating unit by employing said approximate error held in said approximate holding unit; and
an output unit for outputting an output color signal which corresponds to the input color signal outputted from said approximating unit with reference to said color correction table.

2. An image processing apparatus as claimed in claim 1, wherein:
the output color signal outputted from the output unit is constituted by gradation data which can be represented by a device into which said output color signal is entered, and data used to switch said gradation data by way of a dither process operation.

3. An image processing apparatus as claimed in claim 2, wherein:
said image processing apparatus is further comprised of:
a dither processing unit for comparing the data used to switch the gradation data with a dither matrix in which threshold values are arranged to thereby output a dither result; and
an adding unit for adding said dither result to said gradation data.

4. An image processing apparatus as claimed in claim 1, wherein:
said approximating unit compares an inputted color signal with a threshold value provided between said discrete input color signals so as to determine such a discrete color signal which is approximated to said inputted color signal.

5. An image processing apparatus as claimed in claim 3, wherein:
said approximating unit compares an inputted color signal with a threshold value provided between said discrete input color signals so as to determine such a discrete color signal which is approximated to said inputted color signal.

6. An image processing apparatus as claimed in claim 1, wherein:
intervals among said discrete input color signals of said color correction table are not equi-intervals.

7. An image processing apparatus as claimed in claim 5, wherein:
intervals among said discrete input color signals of said color correction table are not equi-intervals.

8. An image processing apparatus as claimed in claim 1, wherein:
said discrete input color signals of said correction table are such color signals which correspond to minimum gradation, maximum gradation, and gradation equal to the respect subdivided points in such a case that a total gradation number of an input color signal is equally subdivided by “N” (symbol “N” being 2, or more positive integers).

9. An image processing apparatus as claimed in claim 5, wherein:
said discrete input color signals of said correction table are such color signals which correspond to minimum gradation, maximum gradation, and gradation equal to the respect subdivided points in such a case that a total gradation number of an input color signal is equally subdivided by “N” (symbol “N” being 2 or more positive integers).

10. An image processing method comprising:
a step for correcting an inputted color signal;
a step for using a color correction table containing a correspondence relationship between a predetermined discrete input color signal and an output color signal in a table form so as to acquire a discrete input color signal which is approximated to said corrected input color signal;
a step for calculating an approximate error based upon both said corrected input color signal and said approximated color signal; and
a step for outputting an output color signal corresponding to said approximated input color signal with reference to said color correction table;
wherein said approximate error is used so as to correct a color signal which is inputted subsequent to the first-mentioned input color signal.

11. An image processing method as claimed in claim 10, wherein:
the output color signal corresponding to said approximated input signal is constituted by gradation data which can be represented by a device into which said output color signal is entered, and data used to switch said gradation data by way of a dither process operation.

12. An image processing method as claimed in claim 11, wherein:
said image processing method is further comprised of:
a step for comparing the data used to switch the gradation data with a dither matrix in which threshold values are arranged to thereby output a dither result; and
a step for adding said dither result to said gradation data.

13. An image processing apparatus as claimed in claim 1, wherein:
said output color signal contains low-frequency noise such as chain-shaped texture, which is produced by both an error diffusion method and an averaged error minimizing method.

14. An image processing method as claimed in claim 10, wherein:
said output color signal contains low-frequency noise such as chain-shaped texture, which is produced by both an error diffusion method and an averaged error minimizing method.
